(19) United States
(12) Patent Application Publication
(10) Pub. No.: US 2002/0093680 A1
(43) Pub. Date: Jul. 18, 2002

(54) Method, system and recording medium for ordering prints

(76) Inventor: Keisuke Tanaka, Kaisei-machi (JP)

Correspondence Address: BIRCH, STEWART, KOLASCH & BIRCH, LLP, P.O. Box 747, Falls Church, VA, 22040-0747, US

(21) Appl. No.: 09/986,476

(22) Filed: Nov. 8, 2001

(30) Foreign Application Priority Data
Nov. 8, 2000 (JP) 339834/2000

(51) Int. Cl. G06F 15/00; B41F 1/00

(52) U.S. Cl. 358/1.15; 358/1.14

(57) ABSTRACT

When a print order is placed for image data via a network, the same image data are prevented from being transferred again and freedom of order placement can be improved in terms of time. The image data transferred to a print order reception center are stored in a database. When a user places an order by using a user terminal, a list of the image data stored in the database is displayed on the user terminal. The user places the order while viewing the list.

### BACKGROUND OF THE INVENTION

1. Field of the Invention

The present invention relates to a method and a system for placing a print order regarding image data via a network, and to a computer-readable recording medium storing a program to cause a computer to execute the print ordering method.

2. Description of the Related Art

There have been known digital photograph service systems for carrying out various kinds of digital photograph services such as storing photographs obtained by users in image servers by digitization of the photographs, recording the photographs in CD-Rs, printing images obtained by users with digital cameras, and receiving orders for additional prints. As one form of such digital photograph service systems, network photograph service systems have also been proposed. In a network photograph service system, print orders or the like are received via a network such as the Internet.

In such a network photograph service system, a user installs viewer software in his/her personal computer which acts as a user terminal for reproducing image data recorded in a CD-R or obtained with a digital camera, and generates order information describing the content of a print order by using an ordering function built in the viewer software. The user then transfers the order information and image data representing an image or images to be printed to an order reception server from the user terminal via a network such as the Internet. The order reception server transfers the image data and the order information to a printer server in a laboratory or in a mini-laboratory of a DPE store. The printer server carries out printing of the image data based on the order information in order to generate additional prints, picture postcards, or photo albums as ordered. In the case where the order reception server and the printer server are placed at the same location, printing is carried out immediately after reception of the image data and the order information.

The print or the prints (hereinafter referred to as the prints) generated in the above manner are delivered to an agency specified by the user at the time of ordering the prints. The user visits the agency and receives the prints after paying a charge.

In the case where the prints are ordered in the network photograph service system described above, the user places the order after sending the image data to the order reception server. After the printing is completed, the order reception server deletes the image data. Therefore, in order to place another order regarding the image data, the image data needs to be transferred again to the order reception server. As a result, the user is burdened with cost and time for communication. Furthermore, since an amount of the image data is large for generating high quality prints, the user may wish to transfer only the image data late at night when the communication cost is comparatively low and to place an order later.

### SUMMARY OF THE INVENTION

The present invention has been conceived based on consideration of the above circumstances. An object of the present invention is therefore to provide a print ordering method and a print ordering system that enable reduction of a burden on a user and to provide a computer-readable recording medium storing a program to cause a computer to execute the print ordering method.

A print ordering method of the present invention is a method used in a print ordering system comprising a server for receiving an order for a print of image data and a user terminal which is connected to the server via a network and used for placing the order for the print of the image data. The print ordering method comprises the steps of:

accepting transfer of the image data to the server and storing the image data in the server regardless of whether or not the order is placed at the time of the transfer of the image data; and

receiving the order for the print of the image data stored in the server after the image data are stored in the server in the case where the order was not placed at the time of the transfer of the image data.

The “server” herein referred to is a server computer installed in a print order reception center or the like for receiving the order for the print. The server is connected to a printer in the case where the printer is placed in the print order reception center. In the case where the print order reception center does not have a printer, the server is connected via the network to a printer server installed in a wholesale laboratory or in a mini-laboratory of a DPE store or the like.

The “transfer of the image data” may refer to transfer of the image data alone to the server with an intention to place the order regarding the image data thereafter. Alternatively, if the order is placed at the time the image data are transferred, the transfer refers to transfer of the image data at the time the order is placed. A user who transfers the image data may place the order for the print. Alternatively, a user different from the user who transfers the image data may place the order.

“Storing the image data in the server may refer to the image data being stored in the server, or in a database or the like connected to the server via the network if the server can access the database.

“Receiving the order . . . after the image data are stored” refers to the case of receiving the order after the image data have been stored in the server for a certain amount of time if the order is not placed at the time the image data are transferred. If the order regarding the image data is placed at the time the image data are transferred, the order is received at the time the image data are transferred and the image data are stored in the server.

In the print ordering method of the present invention, it is preferable for an order reception Web screen to be displayed on the user terminal based on information stored in the server (such as an html file or Java-script) so that the image data can be transferred or the order can be placed via the screen. In this manner, the user can place the order at the time he/she wishes to do so through a comparatively easy operation.

It is also preferable for the print ordering method of the present invention to further comprise the step of displaying on the user terminal a list of the image data stored in the server at the time the order for the print is placed if the order is not placed at the time the image data are transferred.

AS the “list of the image data”, file names of the image data or a preview screen having thumbnail images of the image data may be used, for example.

Moreover, it is preferable for the print ordering method of the present invention to further comprise the step of deleting the image data from the server after a predetermined storage period has elapsed since the image data were put into storage.

The predetermined storage period needs to be notified to the user who transferred the image data, and the user who places the order needs to do so within the storage period.

It is likely that image data for which a print order has been placed once will be subject to further print orders. Therefore, it is preferable for the storage period of the image data for which a print order has been placed to be extended.

The storage period is preferably displayed on the user terminal in the print ordering method of the present invention if the order is not placed at the time the image data are transferred.

A print ordering system of the present invention comprises a server for receiving an order for a print of image data, and a user terminal which is connected to the server via a network and used for placing the order for the print of the image data. In the print ordering system, the server stores the image data transferred thereto regardless of whether or not the order is placed at the time of transfer of the image data, and receives the order for the print regarding the image data stored therein after the image data are stored therein in the case where the order was not placed at the time of the transfer of the image data.

In the print ordering system of the present invention, the server may store the image data at the time the order is received by the server if the order regarding the image data is placed at the time the image data are transferred.

It is preferable for the server in the print ordering system of the present invention to display on the user terminal a list of the image data stored therein at the time the order is placed if the order is not placed at the time the image data are transferred.

It is also preferable for the server in the print ordering system of the present invention to delete the image data after a predetermined storage period has elapsed since the image data were put into storage in the server.

Furthermore, it is preferable for the server in the print ordering system of the present invention to extend the storage period of image data for which the order was placed.

In the print ordering system of the present invention, it is also preferable for the server to display the storage period on the user terminal if the order is not placed at the time the image data are transferred.

The print ordering method of the present invention may be provided as a program in a computer-readable recording medium to cause a computer to execute the print ordering method.

According to the present invention, the image data are stored in the server and the print order is received after the image data are stored if the order is not placed at the time of transfer of the image data. Therefore, the user can transfer the image data at night when communication cost for the network is low and can place the order later, during the daytime, for example. In this manner, freedom of order placement via the network can be improved in terms of time. Furthermore, since the image data are stored in the server, the user does not need to transfer the image data to the server again when placing another order for the same image data that have been transferred and have been printed. In this manner, communication cost and communication time for the transfer of the image data can be saved, which contributes to reduction of a burden on the user.

The list of the image data that have been stored is displayed at the time the user places the order if the order is not placed at the time the image data are transferred. Therefore, the user can confirm the image data that have been sent. Consequently, transfer of the same image data can be prevented.

Furthermore, by deleting the image data from the server after the predetermined storage period has elapsed since the image data were put into storage, the server can be prevented from running short of storage space.

For the image data that have been the subject of an order, the storage period thereof is extended because another print order therefor is likely to be placed. In this manner, the image data do not need to be transferred again for another print order, which also benefits the user.

By displaying the storage period of the image data on the user terminal, the user is prompted to place the print order during the storage period.

### BRIEF DESCRIPTION OF THE DRAWINGS

FIG. 1 is a block diagram showing a configuration of a network photograph service system adopting a print ordering system of an embodiment of the present invention;

FIG. 2 is a diagram showing how image data are stored in a database;

FIG. 3 is a flow chart showing a procedure carried out in this embodiment;

FIG. 4 shows an image selection Web screen;

FIG. 5 is a flow chart showing an uploaded image selection procedure;

FIG. 6 shows an uploaded image search Web screen;

FIG. 7 shows a search result Web screen;

FIG. 8 shows an order content input Web screen;

FIG. 9 shows a preview Web screen;

FIG. 10 shows an image uploading Web screen;

FIG. 11 shows an image preview Web screen;

FIG. 12 is a flow chart showing a procedure carried out in a print order reception center;

FIG. 13 is a flow chart showing a procedure for setting a storage period for the image data; and

FIG. 14 is a flow chart showing a procedure for confirming the storage period for the image data.

### DESCRIPTION OF THE PREFERRED EMBODIMENT

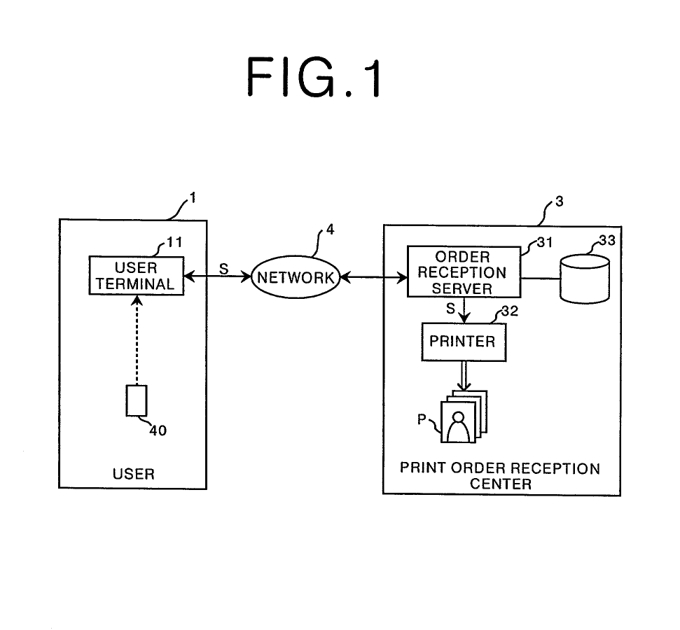

Hereinafter, an embodiment of the present invention will be explained with reference to the accompanying drawings. FIG. 1 is a block diagram showing a configuration of a network photograph service system adopting a print ordering system according to an embodiment of the present invention. The network photograph service system in FIG. 1 exchanges data and prints between a user 1 and a print order reception center 3.

The user 1 has a user terminal 11 such as a personal computer, and can place a print order with the print order reception center 3 via a network 4 regarding image data sets S (stored in a memory card 40) obtained by photographing with a digital camera. In the case where the user 1 does not have a personal computer, the user 1 can use an order processing terminal installed in a service provider or the like which acts as the user terminal 11.

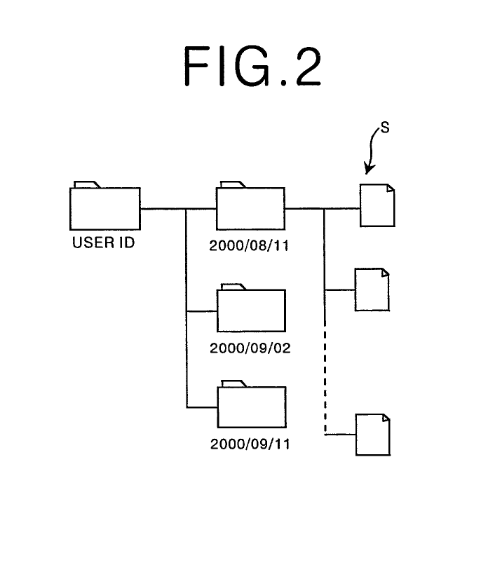

The print order reception center 3 comprises an order reception server 31 for receiving the print order, a printer 32 for generating a print or prints P (hereinafter referred to as the prints P) based on the image data sets S transferred from the user terminal 11 via a network 4, and a database 33 for storing the image data sets S that have been transferred. The database 33 has directories in relation to user IDs, as shown in FIG. 2. Each of the user ID directories further has directories related to the date of uploading, that is, the date of transfer of the image data sets S to the server 31. In each of the directories related to the date, the image data sets S transferred on the date are stored.

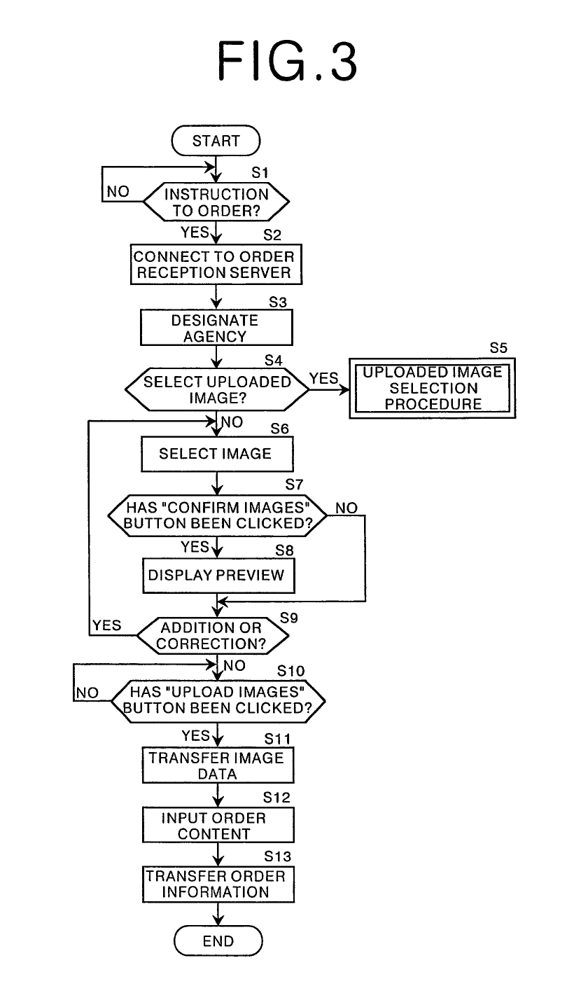

Operation of this embodiment will be explained next. FIG. 3 is a flow chart showing a procedure carried out in this embodiment. The user 1 instructs viewer software installed in the user terminal to place the print order (Step S1), and the viewer software connects the user terminal 11 to the order reception server 31 in the print order reception center 3 via the network 4 by using Web browser software installed in the user terminal 11 (Step S2). A Web screen for placing the print order is then displayed on the user terminal 11, based on information such as an html file or Java-script stored in the order reception server 31. The user 1 inputs information necessary for placing the order, such as a user ID and a password, in the Web screen, and accesses the order reception server 31.

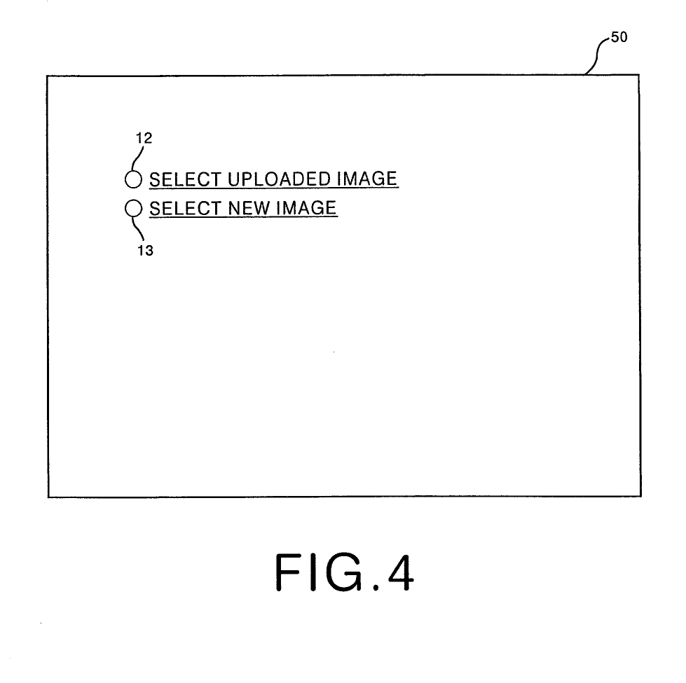

The user 1 specifies an agency at which the user receives the prints P (Step S3). An image selection Web screen 50 is then displayed on the user terminal 11, as shown in FIG. 4. The image selection Web screen 50 displays button 12 for selecting a previously uploaded image or images (hereinafter referred to as the images) to be the subject of the order, and button 13 for selecting newly uploaded images to be the subject of the order. The user 1 clicks either the button 12 or 13, and selects the images to be printed. When the button 12 is clicked to indicate the print order regards the image data sets that have been previously uploaded, an uploaded image selection procedure is carried out (Step S5). The uploaded image data sets may have been stored in the database 33 since a print order was placed at the time the image data were transferred, or since the user 1 transferred only the image data sets to the database 33 beforehand at night when communication cost was low, for example.

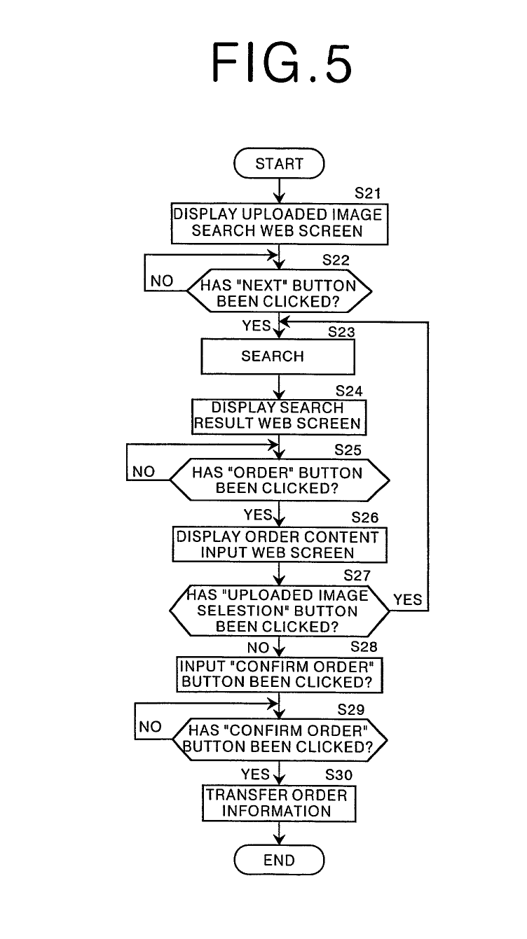

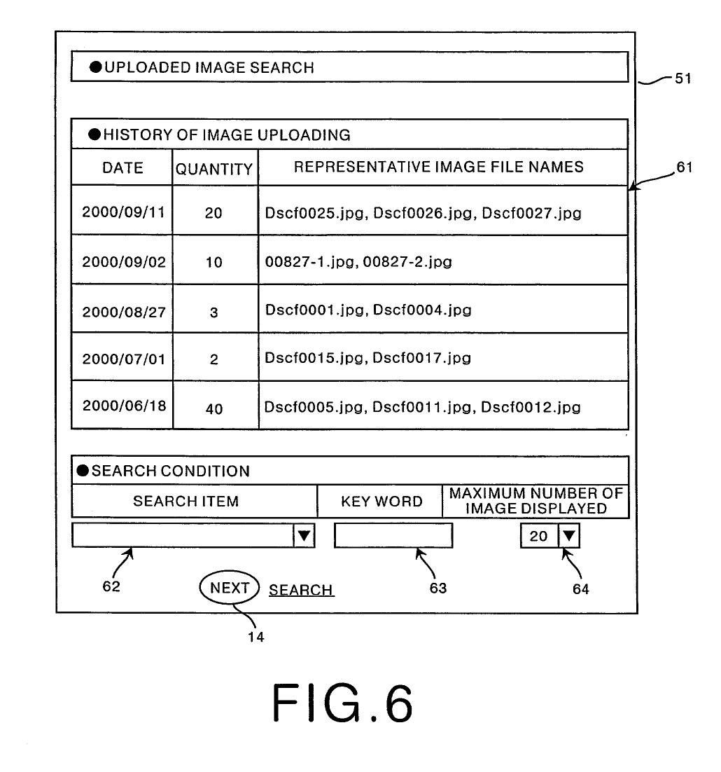

FIG. 5 is a flow chart showing the uploaded image selection procedure. When the button 12 is clicked, an uploaded image search Web screen 51 is displayed on the user terminal 11 as shown in FIG. 6 (Step S21). The uploaded image search Web screen 51 displays an image uploading history 61 in addition to date of uploading, a quantity ordered in the past print order, and representative file names of the images. A search item field 62 for determining a search item, a keyword field 63 for inputting a keyword for search, a maximum image display quantity determination field 64 for determining a maximum number of images to be displayed as a search result, and “Next” button 14 for carrying out the search are displayed in the uploaded image search Web screen 51. The search item field 62 comprises a pull-down menu, and the search item can be selected from none, the date, the quantity, and the file name, for example. The maximum displayed image quantity determination field 64 also comprises a pull-down menu, and the maximum number of the images to be displayed can be selected from the menu.

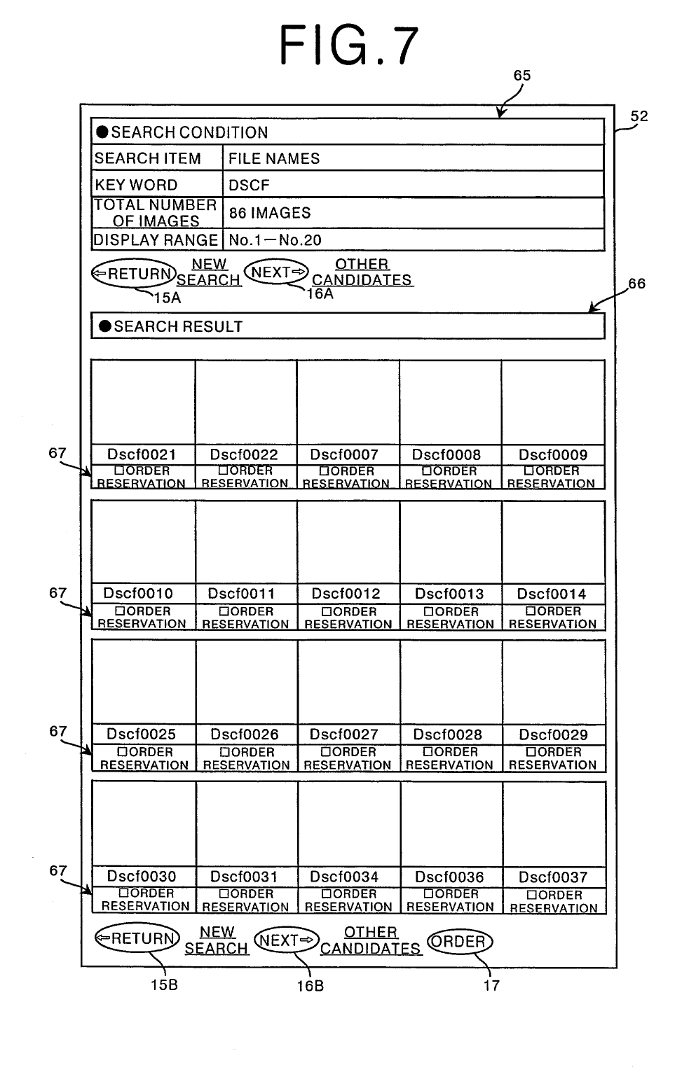

When the user 1 inputs the search item, the keyword, and the maximum number and clicks the “Next” button 14 (Step S22) the database 33 is searched for the image data sets S according to a search condition that has been set (Step S23). A search result Web screen 52 is then displayed as shown in FIG. 7 (Step S24). In this embodiment, the file name and “DSCF” are used as the search item and the keyword, respectively. As shown in FIG. 7, the search result Web screen 52 displays a search condition 65 including the search item, the keyword, the number of images found, and a display range. Search results 66, “Return” buttons 15A and 15B for returning to a previous page, that is, returning to the uploaded image search Web screen 51, “Next” buttons 16A and 16B for displaying other candidates of the images found, and “order” button 17 are also displayed in the search result Web screen 52. The two “Return” buttons and the two “Next” buttons are displayed to ease operation for the user. The search results 66 displays thumbnail images and file names of the images found, and order reservation check boxes 67.

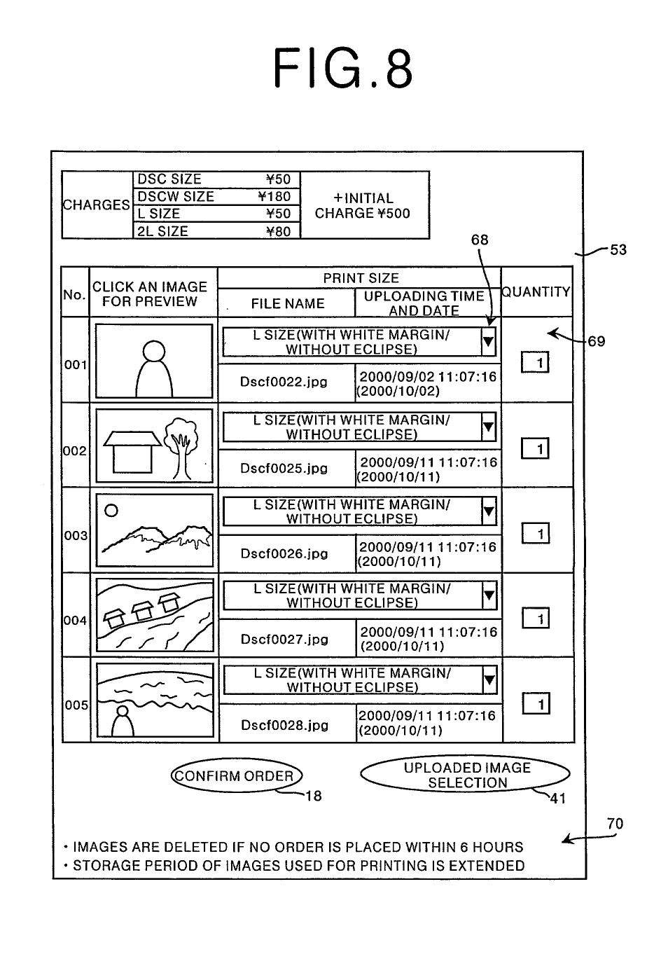

The user 1 selects the images to be printed by checking the order reservation checkboxes 67 therefor. When the “Order” button 17 is clicked (Step S25), an order content input Web screen 53 shown in FIG. 8 is displayed on the user terminal 11 (Step S26). As shown in FIG. 8, the order content input Web screen 53 displays a charge for each print size. For each of the images whose order reservation check boxes have been checked, a number, a thumbnail image, a file name, uploading time and date, a print size selection filed 68, and a print quantity input field 69 are displayed in the order content input Web screen 53. The Web screen 53 also displays a comment field 70, “confirm order” button 18, and “uploaded image selection” button 41. At this time, the images are shown in order of file names. In the uploading time and date field for each of the images, storage expiration date calculated based on a storage period is displayed in a parenthesis, together with the uploading time and date.

The user 1 can confirm the content, the file name, and the uploading time and date for each of the images he/she has selected, by viewing the order content input Web screen 53. Meanwhile, the print size selection field 68 comprises a pull-down menu, and L size (with white margin/without eclipse), L size (with out white margin/with eclipse), DSC size, DSCW size, and 2L size are available, for example. The quantity for each of the images can be input directly in the print quantity input field 69 therefor.

The image data sets S sent to the order reception server 31 are stored in the database 33 for 6 hours, and deleted if no order regarding the image data sets is placed within that time. Therefore, the comment field 70 has a comment “images are deleted if no order is placed within 6 hours”. Furthermore, since the storage period in the database 33 is extended for the image data sets whose printing has been ordered, a comment “storage period of images for which a printing order is received is extended” is also displayed in the field 70. Since the images displayed here were transferred to the order reception server and printed in a previous order, the extended storage period is displayed in the parenthesis of the uploading time and date field for each of the images.

Furthermore, since the storage period for each of the image data sets S stored in the database 33 is written in tag information thereof, the storage period is displayed by referring to the tag information. In the case where a previous order was placed for any one of the image data sets, the extended storage period is written in the tag information thereof. In the case where no order has been placed regarding the image data sets, the storage period of 6 hours is written in the tag information thereof. How the storage period is written will be explained later.

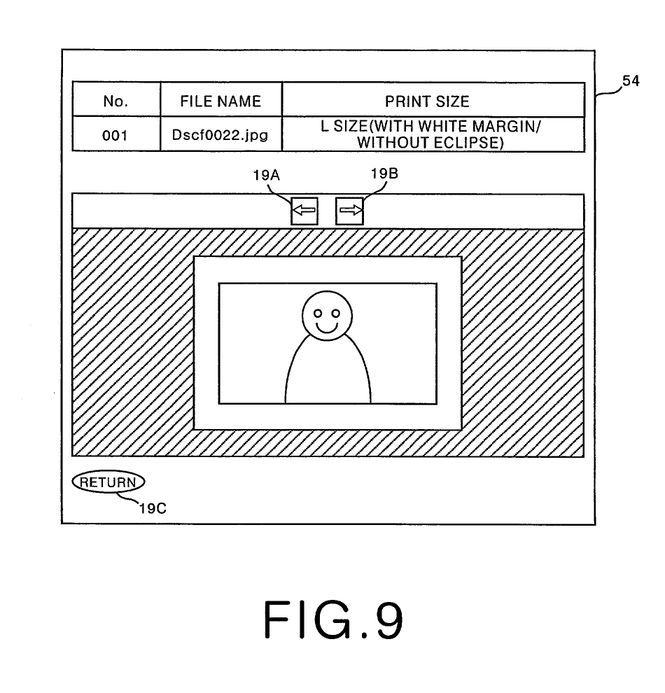

The user 1 selects the print size and clicks one of the thumbnail images. As shown in FIG. 9, the number, the file name, the print size and how the image will look when printed are shown for the image, in a preview Web screen 54. In this example, a thumbnail image for an image No. 001 in L size (with white margin/without eclipse) was clicked. In the preview Web screen 54 shown in FIG. 9, a preview image having a white margin in L size is displayed. By clicking arrow button 19B in the preview web screen 54, the next preview image is displayed. By clicking arrow button 19A, the preview returns to that of the previous image. The order content input Web screen 53 is displayed again when “Return” button 19C is clicked.

The user 1 clicks the “Uploaded image selection” button 41 if the user wishes to change one of the images to be printed. When the button 41 is clicked (Step S27), the procedure returns to Step S23, and the procedure from Step S23 to Step S2 is repeated to select one of the uploaded images. In the case where the user does not need to change the images to be printed, the button 41 is not clicked and a result at Step S27 becomes negative. The user 1 inputs the content of the order in the order content input Web screen 53 (Step S28), and clicks the “confirm order” button 18 (Step S29). The content of the order is transferred as order information to the order reception server 31 (Step S30) to end the procedure.

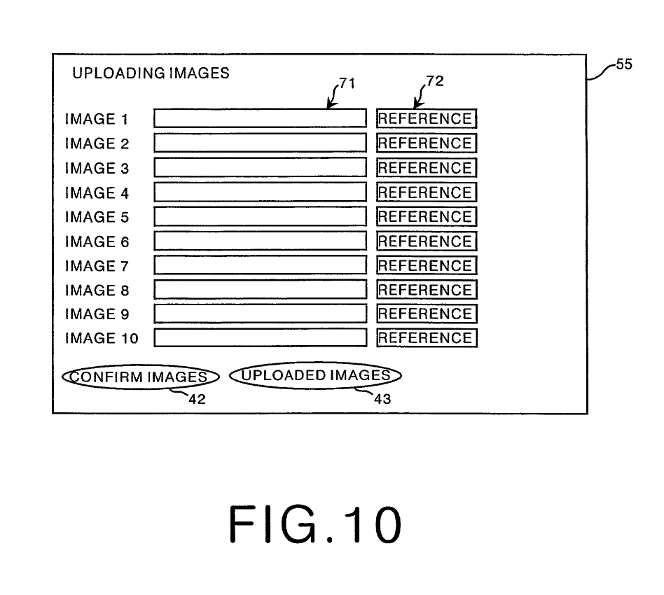

When the button 13 is clicked and a result at Step S4 in FIG. 3 becomes negative, an image uploading Web screen 55 is displayed on the user terminal as shown in FIG. 10. An image uploading procedure, that is, transfer of the image data sets S to the order reception server 31 is carried out in the image uploading Web screen 55. In the image uploading Web screen 55, file name input fields 71 for inputting up to 10 file names, reference buttons 72 each for displaying a file selection dialog box for selecting one of the file names, “Confirm images” button 42 for displaying preview images as will be explained later, and “Upload images” button 43 for uploading the image data sets S are shown.

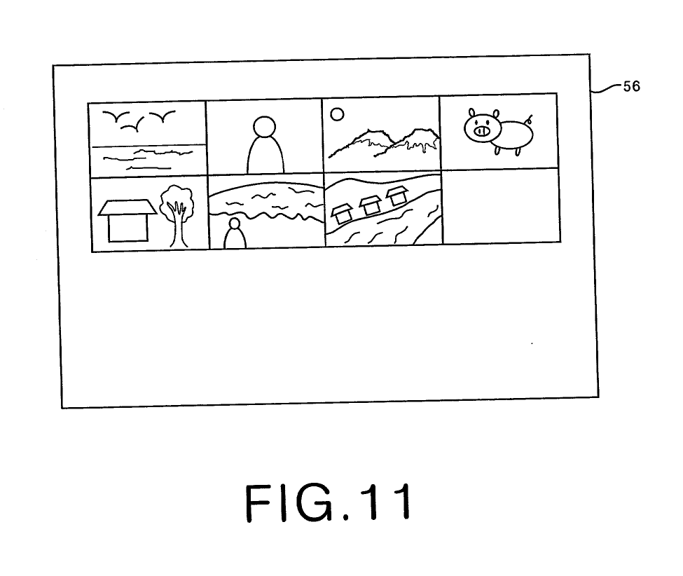

The user 1 selects the images to be printed one by one in the Web screen 55. More specifically, the user 1 selects the images by directly inputting the file names thereof in the file name input fields 71, or by displaying the file selection dialog from which the file names are selected (Step S6). At this time, the file names can be input randomly. Whether or not the “Confirm images” button 42 displayed on the image uploading Web screen 55 has been clicked is then judged (Step S7). If a result at Step S7 is affirmative, an image preview Web screen 56 having the images represented by the image data sets that have been selected is displayed as shown in FIG. 11 (Step S8). It is preferable for the image preview Web screen 56 to be displayed in a window different from a window of the image uploading Web screen 55. The images in the image preview Web screen 56 may be displayed in order of input or in order of file names thereof. After display of the image preview Web screen 56 or in the case where the result at Step S7 is negative, whether or not addition or correction to the images is necessary is judged (Step S9). If a result at Step S9 is affirmative, the procedure returns to Step S6 and the procedure from Step S6 to S9 is repeated. In the case where no correction or no addition is necessary and the“Uploadimages” button 43 is clicked in the image uploading Web screen 55 (Step S10), the selected image data sets are transferred to the order reception server 31 (Step S11).

After the uploading, the order content input Web screen 53 is displayed on the user terminal 11 (see FIG. 8). In this case, the image data sets S after the transfer to the order reception server 31 at Step S11 are displayed in the order content input Web screen 53. The user 1 inputs the content of the order as in the above example (Step S12), and clicks the “confirm order” button 18. The content of the order is then sent as the order information to the order reception server (Step S13) to end the procedure.

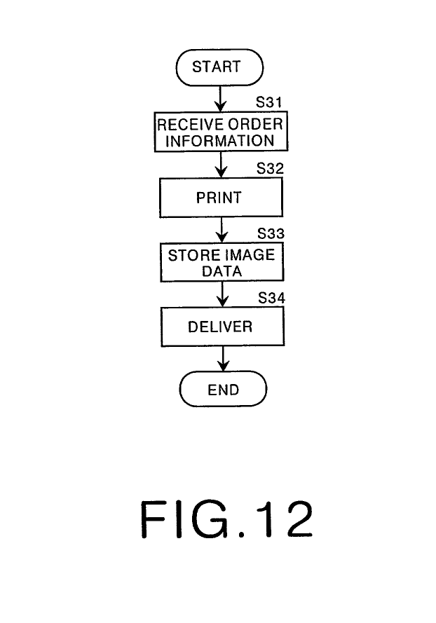

FIG. 12 is a flow chart showing a procedure carried out in the print order reception center 3. The order reception server 31 in the print order reception center 3 receives the order information (Step S31), and carries out printing based on the order information to obtain the prints P (Step S32). Meanwhile, the image data sets S are stored in the database 33 (Step S33). The prints P are then delivered to the agency (Step S34).

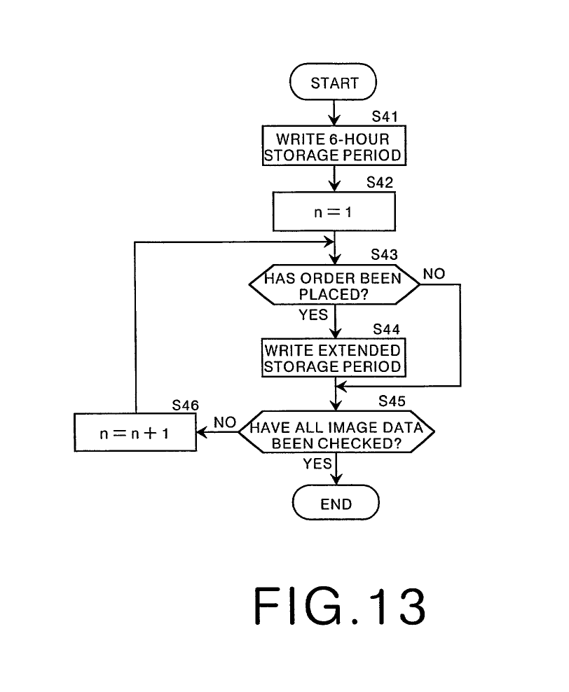

How the storage period is set for the image data sets S transferred to the order reception server 31 will be explained next. FIG. 13 is a flow chart showing a procedure for setting the storage period for the image data sets S that have been transferred. In this example, the number of the image data sets S is n, and one of the numbers from 1 to n is assigned to each of the image data sets. The 6-hour storage period is written in the tag information for the image data sets S that have been transferred and not used for printing (Step S41). First, 1 is set as an initial value of the image data set number (Step S42), and whether or not a previous order was placed for the image data set whose number is 1 is judged (Step S43). In the case where the order has been placed, the extended storage period is written in the tag information of the image data set having the number 1 (Step S44). After the extended storage period has been written in the tag information or in the case where a result at Step S43 is negative, whether or not all the image data sets S have been checked for a previous order is judged (Step S45). If a result at Step S45 is affirmative, the procedure ends. If the result at Step S43 is negative, the procedure from Step S43 to Step S45 is repeated while increasing the image number by 1.

Storage expiration date calculated based on the uploading time and date and the storage period may be written in the tag information.

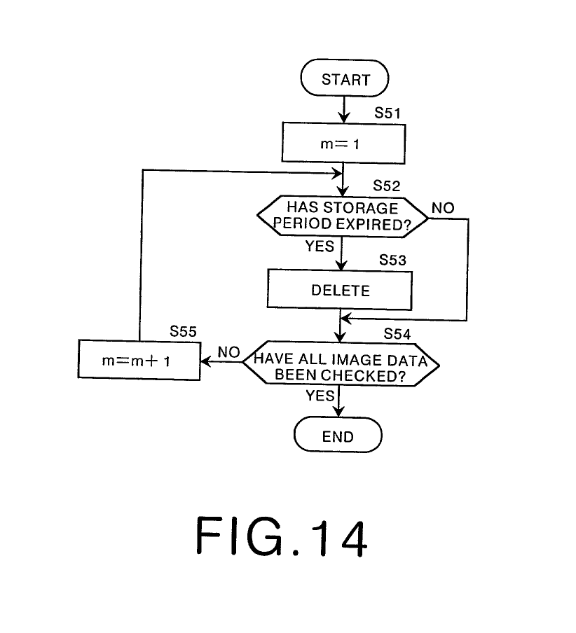

A procedure for confirming the storage period for the image data sets S stored in the database 33 of the order reception server 31 will be explained next. FIG. 14 is a flow chart showing the storage period confirmation procedure for the image data sets S. This procedure is carried out for all the image data sets stored in the database 33 at a predetermined interval (such as every hour or every 2 hours). The number of the image data sets S stored in the database 33 is m in this example. First, 1 is set as an initial value for the image data set number (Step S51). Whether or not the storage period written in the tag information has expired is judged for the image data set whose number is 1 (Step S52). In the case where the storage period has expired, the image data set having the number 1 is deleted from the database 33 (Step S53). After the image data set is deleted or in the case where a result at Step S52 is negative, whether or not the storage period has been checked for all the image data sets is judged (Step S54). If a result at Step S54 is affirmative, the procedure ends. If the result at Step S54 is negative, the procedure returns to Step S52 while increasing the image number by 1, and the procedure from Step S52 to S54 is repeated.

As has been described above, in this embodiment, the image data sets S transferred to the order reception server 31 at the time of placing the order are stored in the database 33 of the order reception server 31. Therefore, in the case where the image data S that have been transferred previously are used again for printing, the image data sets S do not need to be transferred again to the order reception server 31. As a result, communication cost and communication time for transfer of the image data sets S are saved and a burden on the user can be reduced.

In the above embodiment, the image data sets S whose printing was ordered in the past are stored in the database 33 of the order reception server 31. However, only the image data S may also be transferred and stored in the database 33 without involving an order therefor. In this manner, the user can transfer the image data sets S at night when the communication cost is low for the network, and place the order later, during the daytime. Therefore, freedom of order placement via the network can be improved in terms of time.

In the above embodiment, the storage period is extended for the image data sets S whose printing was ordered previously. However, the storage period may be extended for all the image data sets transferred together with the image data sets S whose printing was previously ordered. As for the storage period, 6 hours is set for the image data sets whose printing has not been ordered. However, regardless of a previous order being placed or not, the storage period may be several months. Furthermore, all the images transferred from the user may be stored without a storage period therefor. In this case, the image data sets are deleted from the database 33 upon request of the user 1. The storage period may also be extended if a charge is paid therefor.

The storage period may be set in accordance with how frequently the user 1 uses the network photograph service system. For example, for a frequent user, the storage period may be set longer than for a user who does not use the system often.

In the case where the image data sets S are printed as picture postcards such as for New Year's greeting or for Christmas, it is preferable for the storage period to be set for each use of cards. For example, if the image data sets are printed as New Year's greeting cards, the storage period is set to expire on January 10, while the period is set on December 25 for the image data sets for Christmas cards.

In the above embodiment, the image data sets S transferred by the user 1 are stored in the database 33 and the same user 1 places the order for the image data sets. However, an order for the image data sets of another user stored in the database 33 may be placed.

What is claimed is:

1. A print ordering method used in a print ordering system comprising a server for receiving an order for a print of image data and a user terminal which is connected to the server via a network and used for placing the order for the print of the image data, the print ordering method comprising the steps of:
accepting transfer of the image data to the server and storing the image data in the server regardless of whether or not the order is placed at the time of the transfer of the image data; and
receiving the order for the print of the image data stored in the server after the image data are stored in the server in the case where the order was not placed at the time of the transfer of the image data.

2. A print ordering method as defined in claim 1, wherein the step of accepting and storing the image data is the step of accepting and storing the image data at the time the order is received if the order is placed at the time the image data are transferred.

3. A print ordering method as defined in claim 1, further comprising the step of displaying on the user terminal a list of the image data stored in the server at the time the order for the print is placed if the order is not placed at the time the image data are transferred.

4. A print ordering method as defined in any one of claims 1 to 3, further comprising the step of deleting the image data from the server after a predetermined storage period has elapsed since the image data were put into storage.

5. A print ordering method as defined in claim 4, further comprising the step of extending the storage period for the image data regarding which the order was placed.

6. A print ordering method as defined in claim 4, further comprising the step of displaying the storage period on the user terminal.

7. A print ordering method as defined in claim 5, further comprising the step of displaying the storage period on the user terminal.

8. A print ordering system comprising a server for receiving an order for a print of image data and a user terminal which is connected to the server via a network and used for placing the order for the print of the image data, wherein
the server stores the image data transferred thereto regardless of whether or not the order is placed at the time of transfer of the image data, and receives the order for the print regarding the image data stored therein after the image data are stored therein in the case where the order was not placed at the time of the transfer of the image data.

9. A print ordering system as defined in claim 8, wherein the server stores the image data at the time the order is received by the server if the order is placed regarding the image data at the time the image data are transferred.

10. A print ordering system defined in claim 8, wherein the server displays on the user terminal a list of the image data stored therein at the time the order is placed if the order is not placed at the time the image data are transferred.

11. A print ordering system as defined in any one of claims 8 and 10, wherein the server deletes the image data after a predetermined storage period has elapsed since the image data were put into storage in the server.

12. A print ordering system as defined in claim 11, wherein the server extends the storage period of the image data regarding which the order was placed.

13. A print ordering system as defined in claim 11, wherein the server displays the storage period on the user terminal.

14. A print ordering system as defined in claim 12, wherein the server displays the storage period on the user terminal.

15. A computer-readable recording medium storing a program to cause a computer to execute a print ordering method used in a print ordering system, the print ordering system comprising a server for receiving an order for a print of image data and a user terminal which is connected to the server via a network and used for placing the order for the print of the image data, the program comprising the procedures of:
accepting transfer of the image data to the server and storing the image data in the server regardless of whether or not the order is placed at the time of the transfer of the image data; and
receiving the order for the print of the image data stored in the server after the image data are stored in the server in the case where the order was not placed at the time of the transfer of the image data.

16. A computer-readable recording medium as defined in claim 15, wherein the procedure of accepting and storing the image data is the procedure of accepting and storing the image data at the time the order is received if the order is placed at the time the image data are transferred.

17. A computer-readable recording medium as defined in claim 15, the program further comprising the procedure of displaying on the user terminal a list of the image data stored in the server at the time the order for the print is placed if the order is not placed at the time the image data are transferred.

18. A computer-readable recording medium as defined in any one of claims 15 to 17, the program further comprising the procedure of deleting the image data from the server after a predetermined storage period has elapsed since the image data were put into storage.

19. A computer-readable recording medium as defined in claim 18, the program further comprising the procedure of extending the storage period for the image data regarding which the order was placed.

20. A computer-readable recording medium as defined in claim 18, the program further comprising the procedure of displaying the storage period on the user terminal.

21. A computer-readable recording medium as defined in claim 19, the program further comprising the procedure of displaying the storage period on the user terminal.
